(19) United States
(12) Patent Application Publication
(10) Pub. No.: US 2026/0197051 A1
(43) Pub. Date: Jul. 9, 2026

(54) TWO-STAGE NON-ZERO COEFFICIENT BITMAP FOR TRANSMISSION-RECEPTION-POINT-SPECIFIC COHERENT JOINT TRANSMISSION CHANNEL STATE INFORMATION REPORTING

(71) Applicant: QUALCOMM Incorporated, San Diego, CA (US)

(72) Inventors: Jing DAI, Beijing (CN); Min HUANG, Beijing (CN); Chao WEI, Beijing (CN)

(21) Appl. No.: 19/127,945

(22) PCT Filed: Jan. 31, 2023
(86) PCT No.: PCT/CN2023/073930

§ 371 Date: May 7, 2025

(51) Int. Cl. H04B 7/06; H04W 72/0453

(52) U.S. Cl. CPC H04B 7/0626; H04W 72/0453

(57) ABSTRACT

Various aspects of the present disclosure generally relate to wireless communication. In some aspects, a user equipment (UE) may receive configuration information associated with reporting channel state information (CSI) associated with a plurality of transmission reception points (TRPs) for multiple TRP (mTRP) coherent joint transmission (CJT). The UE may receive a plurality of channel state information (CSI) reference signals (CSI-RSs) from the plurality of TRPs. The UE may transmit a reporting communication based on the configuration information and the plurality of CSI-RSs, the reporting communication comprising two-stage non-zero coefficient (NZC) bitmaps including: a first NZC bitmap comprising a plurality of all-zero indications, each all-zero indication corresponding to a respective TRP of the plurality of TRPs and a respective communication layer of a plurality of communication layers; and the two-stage NZC bitmaps may include a second NZC bitmap indicating the first set of CSI coefficients. Numerous other aspects are described.

### FIELD OF THE DISCLOSURE

Aspects of the present disclosure generally relate to wireless communication and to techniques and apparatuses for two-stage non-zero coefficient bitmaps for transmission-reception-point-specific coherent joint transmission channel state information reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive configuration information associated with reporting channel state information (CSI) associated with a plurality of transmission reception points (TRPs) for multiple TRP (mTRP) coherent joint transmission (CJT). The one or more processors may be configured to receive a plurality of channel state information (CSI) reference signals (CSI-RSs) from the plurality of TRPs. The one or more processors may be configured to transmit a reporting communication based on the configuration information and the plurality of CSI-RSs, the reporting communication comprising two-stage non-zero coefficient (NZC) bitmaps including, a first NZC bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second NZC bitmap indicating the first set of CSI coefficients.

Some aspects described herein relate to a network node for wireless communication. The network node may include a memory and one or more processors coupled to the memory. The one or more processors may be configured to transmit configuration information associated with reporting CSI associated with a plurality of TRPs for mTRP CJT, the configuration information indicating a two-stage NZC bitmap configuration. The one or more processors may be configured to transmit a plurality of CSI-RSs from the plurality of TRPs. The one or more processors may be configured to receive a reporting communication based on the configuration information and the plurality of CSI-RSs, the reporting communication comprising, a first bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second bitmap indicating the first set of CSI coefficients.

Some aspects described herein relate to a method of wireless communication performed by a UE. The method may include receiving configuration information associated with reporting CSI associated with a plurality of TRPs for mTRP CJT. The method may include receiving a plurality of CSI-RSs from the plurality of TRPs. The method may include transmitting a reporting communication based on the configuration information and the plurality of CSI-RSs, the reporting communication comprising two-stage NZC bitmaps including, a first NZC bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second NZC bitmap indicating the first set of CSI coefficients.

Some aspects described herein relate to a method of wireless communication performed by a network node. The method may include transmitting configuration information associated with reporting CSI associated with a plurality of TRPs for mTRP CJT, the configuration information indicating a two-stage NZC bitmap configuration. The method may include transmitting a plurality of CSI-RSs from the plurality of TRPs. The method may include receiving a reporting communication based on the configuration information and the plurality of CSI-RSs, the reporting communication comprising, a first bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second bitmap indicating the first set of CSI coefficients.

Some aspects described herein relate to a non-transitory computer-readable medium that stores a set of instructions for wireless communication by a UE. The set of instructions, when executed by one or more processors of the UE, may cause the UE to receive configuration information associated with reporting CSI associated with a plurality of TRPs for mTRP CJT. The set of instructions, when executed by one or more processors of the UE, may cause the UE to receive a plurality of CSI-RSs from the plurality of TRPs. The set of instructions, when executed by one or more processors of the UE, may cause the UE to transmit a reporting communication based on the configuration information and the plurality of CSI-RSs, the reporting communication comprising two-stage NZC bitmaps including, a first NZC bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second NZC bitmap indicating the first set of CSI coefficients.

Some aspects described herein relate to a non-transitory computer-readable medium that stores a set of instructions for wireless communication by a network node. The set of instructions, when executed by one or more processors of the network node, may cause the network node to transmit configuration information associated with reporting CSI associated with a plurality of TRPs for mTRP CJT, the configuration information indicating a two-stage NZC bitmap configuration. The set of instructions, when executed by one or more processors of the network node, may cause the network node to transmit a plurality of CSI-RSs from the plurality of TRPs. The set of instructions, when executed by one or more processors of the network node, may cause the network node to receive a reporting communication based on the configuration information and the plurality of CSI-RSs, the reporting communication comprising, a first bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second bitmap indicating the first set of CSI coefficients.

Some aspects described herein relate to an apparatus for wireless communication. The apparatus may include means for receiving configuration information associated with reporting CSI associated with a plurality of TRPs for mTRP CJT. The apparatus may include means for receiving a plurality of CSI-RSs from the plurality of TRPs. The apparatus may include means for transmitting a reporting communication based on the configuration information and the plurality of CSI-RSs, the reporting communication comprising two-stage NZC bitmaps including, a first NZC bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second NZC bitmap indicating the first set of CSI coefficients.

Some aspects described herein relate to an apparatus for wireless communication. The apparatus may include means for transmitting configuration information associated with reporting CSI associated with a plurality of TRPs for mTRP CJT, the configuration information indicating a two-stage NZC bitmap configuration. The apparatus may include means for transmitting a plurality of CSI-RSs from the plurality of TRPs. The apparatus may include means for receiving a reporting communication based on the configuration information and the plurality of CSI-RSs, the reporting communication comprising, a first bitmap comprising a plurality of all-zero indications, each all-zero indication of the plurality of all-zero indications corresponding to a respective TRP of the plurality of TRPs and a respective communication layer of a plurality of communication layers, where a first all-zero indication, of the plurality of all-zero indications, indicates that a first set of CSI coefficients, associated with a first TRP of the plurality of TRPs and a first communication layer of the plurality of communication layers, comprises at least one NZC. The two-stage NZC bitmaps may include a second bitmap indicating the first set of CSI coefficients.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiple transmission reception point (mTRP) communication, in accordance with the present disclosure.

FIG. 5 is a diagram illustrating an example associated with two-stage non-zero coefficient (NZC) bitmaps for TRP-specific coherent joint transmission (CJT) channel state information (CSI) reporting in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

To receive a joint communication from the multiple transmission reception points (TRPs), a single wide beam corresponding to a single transmission configuration indicator (TCI) state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a coherent joint transmission (CJT) configuration can be used for a coherent joint communication to facilitate more efficient application of spatial filters, which can result in fewer missed signals and more spectral efficiency.

A CJT configuration can be used for physical downlink shared channel (PDSCH) communications, physical uplink control channel (PUCCH) communications, and/or physical uplink shared channel (PUSCH) communications. A CJT is a joint transmission in which each layer (which may be referred to herein as a “communication layer”) of the joint transmission is transmitted with a respective phase such that the layers can be constructively combined at a receiving device.

In some cases, a multi-TRP (mTRP) CJT codebook can be used for port selection in mTRP CJT scenarios. In some cases, the mTRP CJT codebook can be from the Rel-16 eType-II CSI codebook or the Rel-17 FeType-II CSI port selection codebook. However, in the mTRP CJT scenario, due to possible different propagation channel properties among TRPs, each TRP may be associated with a respective rank (layer). For the Type-II codebook refinement for CJT mTRP, the bitmaps for indicating the locations of non-zero coefficients (NZCs) can reuse a legacy design. TRP-specific rank can result in near all-zero CSI coefficients for some TRPs at some layers. Thus, reporting all-zero coefficients with a bitmap may constitute an inefficient use of communication resources and/or computation resources.

Various aspects relate generally to using two-stage NZC bitmaps for Type-II CSI associated with mTRP CJT. Some aspects more specifically relate to receiving, at a UE, configuration information associated with reporting CSI associated with a plurality of TRPs for mTRP CJT and reporting the CSI based on receiving a plurality of CSI-RSs. In some aspects, the UE may report the CSI using a reporting communication that may be an mTRP CJT CSI report including a Type-II port selection codebook. In some aspects, the reporting communication may include two-stage NZC bitmaps. A first stage NZC bitmap may include all-zero indications that indicate whether, for a respective TRP and a respective communication layer (e.g., rank), the CSI coefficient matrix includes all zeros or at least one NZC. For each combination of TRP and communication layer associated with a CSI coefficient matrix having at least one NZC, a second stage NZC bitmap may indicate the CSI coefficients.

Particular aspects of the subject matter described in this disclosure can be implemented to realize one or more of the following potential advantages. In some examples, the described techniques can be used to extend Type-II codebook refinement for mTRP CJT scenarios, thereby providing for CSI acquisition for mTRP CJT. In some examples, the described techniques can be used to facilitate more efficient use of CSI resources and/or computational resources for reporting CSI for mTRP CJT.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

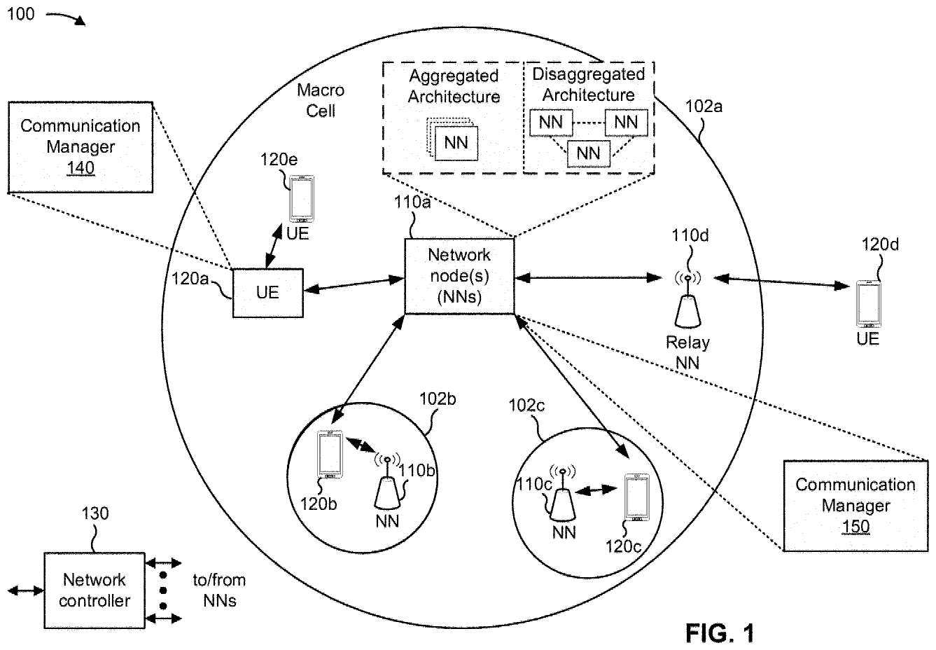

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive configuration information associated with reporting channel state information (CSI) associated with a plurality of TRPs for multiple TRP (mTRP) CJT; receive a plurality of channel state information (CSI) reference signals (CSI-RSs) from the plurality of TRPs; and transmit a reporting communication based on the configuration information and the plurality of CSI-RSs, the reporting communication comprising two-stage non-zero coefficient (NZC) bitmaps including: a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second NZC bitmap indicating the first set of CSI coefficients. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit configuration information associated with reporting CSI associated with a plurality of TRPs for multiple TRP (mTRP) CJT, the configuration information indicating a two-stage NZC bitmap configuration; transmit a plurality of CSI-RSs from the plurality of TRPs; and receive a reporting communication based on the configuration information and the plurality of CSI-RSs, the reporting communication comprising: a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second bitmap indicating the first set of CSI coefficients. Additionally, or alternatively, the communication manager 150 may perform one or more other operations described herein.

As indicated above, FIG. 1 is provided as an example. Other examples may differ from what is described with regard to FIG. 1.

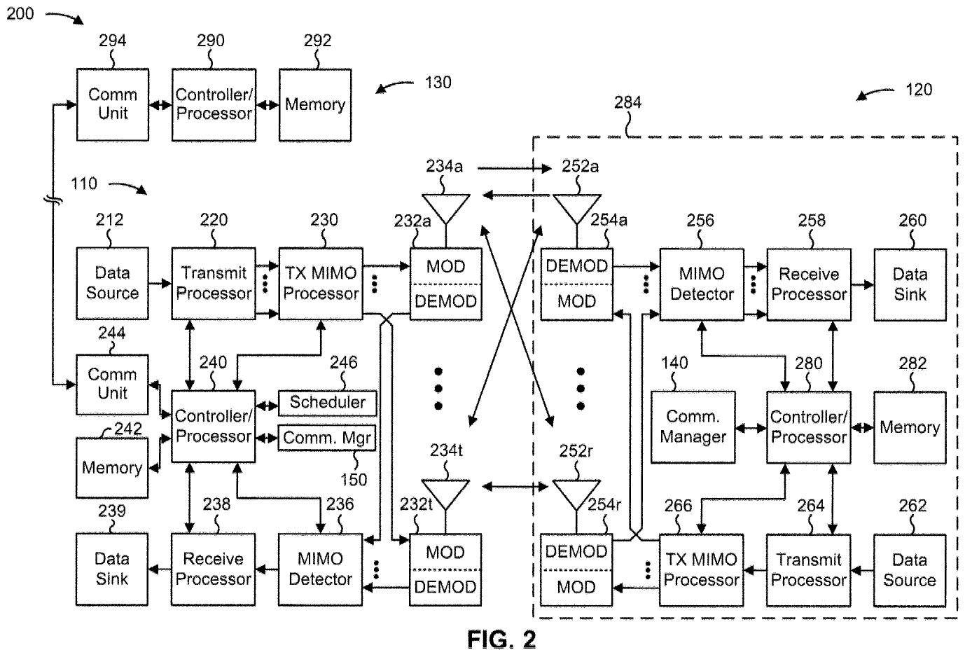

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

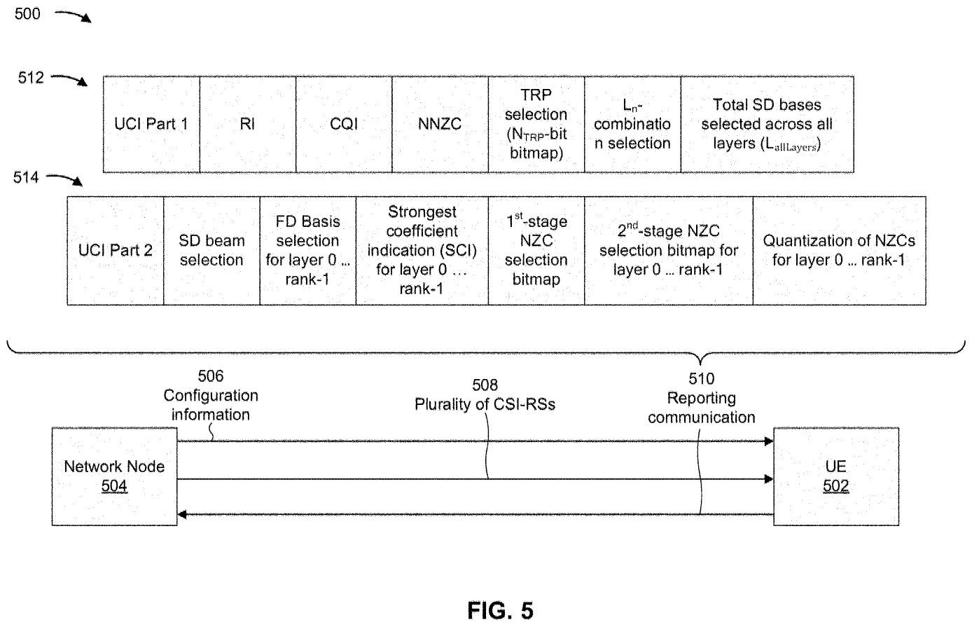

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

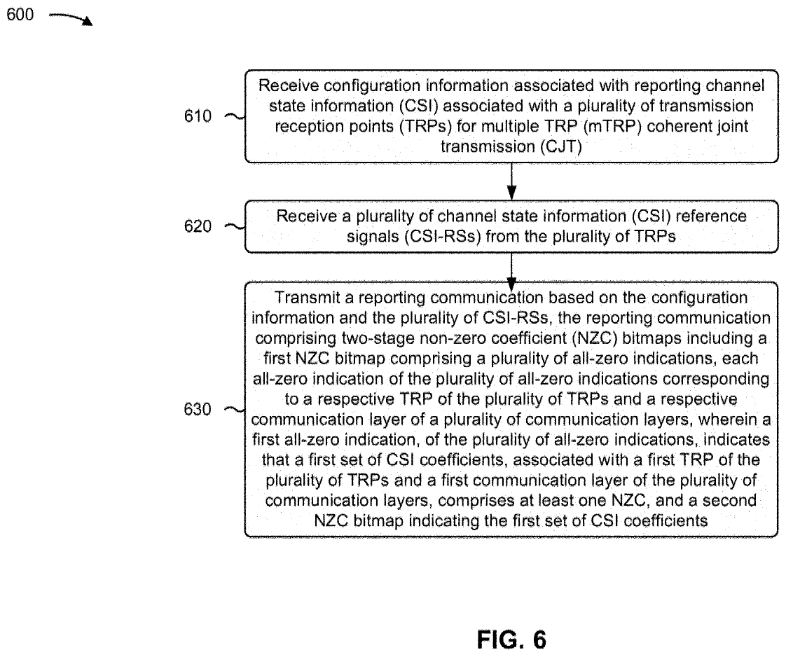

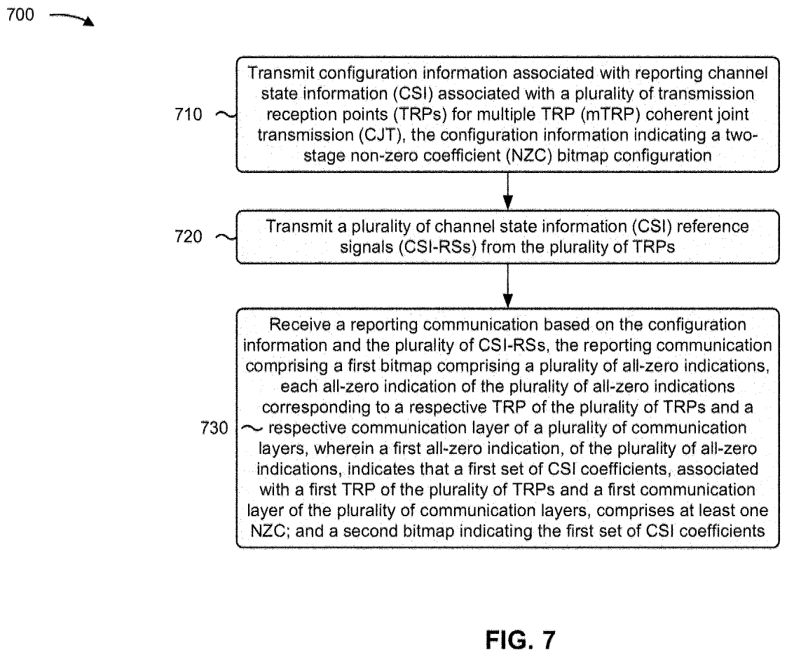

The controller/processor 240 of the network node 110, the controller/processor 280 of the UE 120, and/or any other component(s) of FIG. 2 may perform one or more techniques associated with two-stage NZC bitmaps for TRP-specific CJT CSI reporting, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information associated with reporting CSI associated with a plurality of TRPs for multiple TRP (mTRP) CJT; means for receiving a plurality of CSI-RSs from the plurality of TRPs; and/or means for transmitting a reporting communication based on the configuration information and the plurality of CSI-RSs, the reporting communication comprising two-stage NZC bitmaps including: a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and/or a second NZC bitmap indicating the first set of CSI coefficients. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting configuration information associated with reporting CSI associated with a plurality of TRPs for multiple TRP (mTRP) CJT, the configuration information indicating a two-stage NZC bitmap configuration; means for transmitting a plurality of CSI-RSs from the plurality of TRPs; and/or means for receiving a reporting communication based on the configuration information and the plurality of CSI-RSs, the reporting communication comprising: a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and/or a second bitmap indicating the first set of CSI coefficients. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

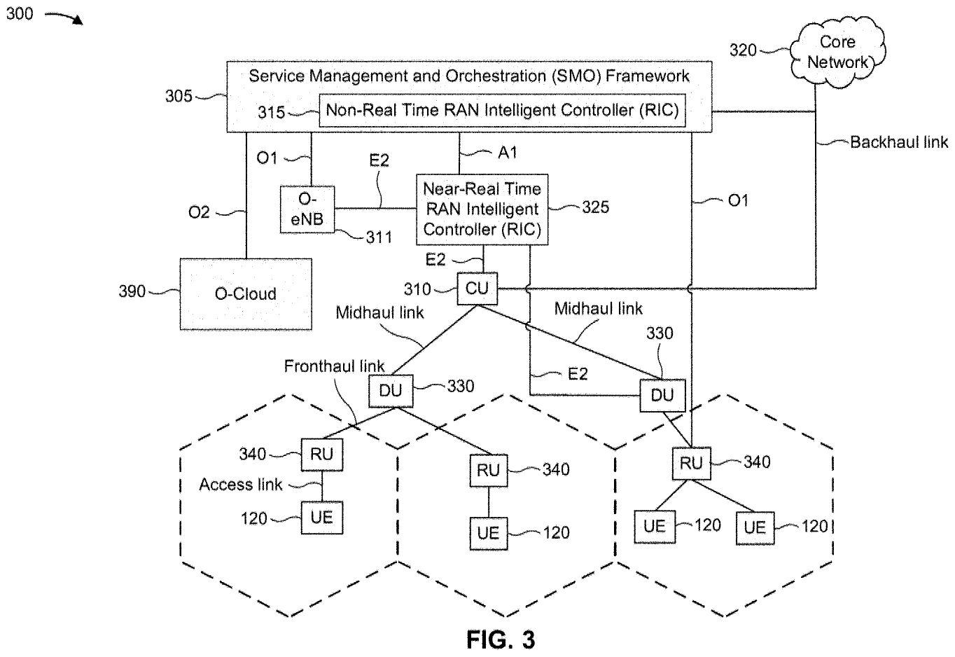

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A network node (e.g., network node 110) can transmit many beams to a UE (e.g., UE 120). “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. For example, the network node can generate the beams using an antenna panel that generates beams at a spatial and/or phase displacement from each other. The network node and the UE can select a set of beams that are to be used for communication between the network node and the UE. For example, the set of beams transmitted from the network node to the UE can be referred to herein as a communication link, a downlink, and/or the like. The communication link between the network node and the UE can propagate in a medium and/or through various geometric paths, which are collectively referred to herein as a channel between the network node and the UE.

In some aspects, the UE can select a set of beams for communication with the network node. For example, the UE can select the set of beams based at least in part on the set of beams being associated with favorable characteristics (e.g., a satisfactory receive power, a satisfactory signal to interference plus noise (SINR) value, etc.). The UE can generate a codeword that indicates the set of beams and parameters to be used for using a codebook based at least in part on performing channel estimation of the channel between the network node and the UE.

One such codebook is the type-II codebook, prescribed in 5G/NR. The type-II codebook can use a two-stage procedure to generate the codeword: a first stage wherein the set of beams is selected for a wideband of the communication link (e.g., sometimes referred to herein as W1), and a second stage wherein linear combination is performed, for a set of subbands, using the set of beams for each set of subbands. The codeword can be based at least in part on the linear combination, and can indicate the set of beams and/or respective amplitudes, phase coefficients, and/or the like. Thus, the UE can provide an indication of channel state at the UE and can request the set of beams to be used for the UE. The type-II codebook can provide more precise specification of the channel state than a type-I codebook, which can provide a predefined codeword-based approach to specifying selected beams. Thus, the type-II codebook can be referred to as a high resolution codebook in comparison to the type-I codebook. The type-II codebook can improve multi-user multiple input multiple output (MU-MIMO) performance on the communication link.

For one type of type-II codebook (e.g., the codebook specified in Release 15 of the 3GPP standard for 5G/NR), the precoder of the codebook is based at least in part on a linear combination of discrete Fourier transform (DFT) beams. The linear combination may define the precoder W as W=W₁W₂, wherein the spatial domain compression matrix

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] ,$$

wherein

$${\{ {v}_{i} \}}_{i = 0}^{L - 1}$$

are L spatial domain basis vectors of dimension N₁N₂×1 (mapped to the two polarizations, so 2L in total), P=2N₁N₂ indicates a number of dimensions (sometimes represented as D), and the combination coefficient matrix W₂ is composed of K=2Lυ linear combination coefficients, where υ indicates a total number of layers. Each column in W₂ indicates the linear combination of complex coefficients (i.e., amplitude and phase) for one layer, wherein the amplitude coefficient is given by

$${\{ {p}_{i}^{( 1 )} {p}_{i}^{( 2 )} \}}_{i = 0}^{2 L - 1}$$

for l=0, . . . , v−1, and

$${p}_{i}^{( 1 )} and {p}_{i}^{( 2 )}$$

are the wideband and subband coefficients, respectively. The phase coefficient is given by

$${\{ {c}_{l , i} \}}_{i = 0}^{2 L - 1}$$

for l=0, . . . , v−1, and ci is one of the 8 phase shift keying (8PSK) or the quadrature phase shift keying (QPSK) constellation points.

The UE can report the above values and/or other values associated with channel estimation using CSI feedback. CSI feedback for the type-II codebook can include two parts: a first part, sometimes referred to as CSI part I, and a second part, sometimes referred to as CSI part II. In some cases, the first part can have a smaller payload than the second part, and/or can have a fixed payload. For example, the first part can have a payload size of less than approximately 50 bits, whereas the second part can have a variable payload size that may be dependent on the first part. In some cases, the second part can have a payload size of approximately 100 bits to 600 bits, although other values can be used.

In some cases, the first part can identify one or more of: a rank indicator (RI) (e.g., 1 bit to indicate one layer υ=1 or two layers υ=2 when the configured maximum rank is 2); wideband and subband differential channel quality indicators (CQI), for which a total payload size may be dependent on the number of subbands (e.g., approximately 4+18×2=40 bits for 19 subbands); and/or an indication of the number of non-zero wideband amplitude coefficients Qₗ for each layer; among other examples. In some cases, the second part can identify one or more of: wideband and/or subband precoding matrix indicators (PMIs) including a spatial basis vector selection indication; wideband and subband amplitude coefficients; and/or subband phase coefficients; among other examples.

In some cases, the type-II CSI feedback can use a compressed type-II precoder. This can reduce overhead of type-II CSI feedback. The compressed precoder can exploit the sparsity of the spatial domain and/or the frequency domain. For example, an example of a compressed type-II precoder W is given by

$$W = {W}_{1} {\tilde{W}}_{2} {W}_{f}^{H} ,$$

wherein the precoder matrix W has P=2N₁N₂ rows (representing the spatial domain and the number of ports) and N₃ columns (wherein N₃ is a frequency-domain compression unit of resource blocks or reporting subbands). The W₁ matrix, described above, is the spatial basis consisting of L beams per polarization group (hence a total of 2L beams). The \tilde{W}₂ matrix indicates all of the required linear combination complex coefficients (amplitude and co-phasing), referred to herein as “CSI coefficients”, similarly to what is described above. The W_{f} matrix is composed of the basis vectors used to perform compression in frequency domain, W_{f}=[f₀ f₁ . . . f_{M-1}], where

$${\{ {f}_{m} \}}_{m = 0}^{M - 1}$$

are M size-N₃×1 orthogonal DFT vectors for each spatial basis i=0, . . . , 2L−1. The above type-II CSI feedback may be referred to in some cases as enhanced or modified type-II CSI feedback (e.g., enhanced relative to an approach that does not use basis vectors in the spatial and frequency domains to compress feedback size).

The CSI feedback for this enhanced type-II CSI feedback can include a spatial domain basis vector selection that is similar to the approach described in connection with the type-II CSI feedback configuration. The CSI feedback can further include a frequency-domain (FD) basis subset selection (wherein M out of a total N₃ basis vectors are selected). In some cases, common FD basis vectors for all the 2L spatial beams can be used, which is referred to herein as Alternative 1. In these cases, M basis vectors are dynamically selected and reported. The value of M can be configured by the network or reported by the UE. In other cases, referred to herein as Alternative 2, independent FD basis vectors can be used for each spatial domain basis vector, with potentially different numbers and/or selections of FD basis vectors for each spatial domain basis vector. The total number of FD basis vectors across all the 2L spatial beams can be configured.

The enhanced type-II CSI feedback may further include the FD coefficients (e.g., amplitude and phase) in \tilde{W}₂. For Alternative 1 (the common FD basis vector subset selection), the enhanced type-II CSI feedback can report only a subset K₀<K=2 LM of the coefficients. For Alternative 2 (the independent basis subset selection), the enhanced type-II CSI feedback can report

$$K = {\sum }_{i = 0}^{2 L - 1} {M}_{i}$$

amplitude ana phase coefficients, wherein Mi is the number of FD basis vectors associated with one spatial beam.

With regard to the Type-II codebook refinement for CJT mTRP, the selection of N CSI-RS resources can be performed by the UE and reported as a part of a CSI report where NE {1, . . . , N_{TRP}}. N is the number of cooperating CSI-RS resources, while N_{TRP} is the maximum number of cooperating CSI-RS resources configured by gNB via higher-layer signalling. The selection of N out of N_{TRP} CSI-RS resources can be reported via an N_{TRP}-bit bitmap in CSI part 1, where the value of N can be inferred from the selection. A restricted configuration (network-configured via higher-layer signalling) where N=N_{TRP} can be supported. In some cases, the N_{TRP}-bit bitmap is not reported when the restriction is configured.

With regard to the Type-II codebook refinement for CJT mTRP, regarding the SD basis selection, for a configured value of N_{TRP}, a set of N_{L} combinations of values for {L₁, . . . , L_{NTRP}} can be network-configured via higher-layer (RRC) signaling. When N_{L}>1, the selected combination of values for {L₁, . . . , L_{NTRP}} can be reported in CSI part 1 using an indicator, selected from the N_{L} configured combinations. N_{L}=1 is one of the supported candidate values. The SD basis selection for the n-th (n=1, . . . , N) selected CSI-RS resource can be indicated in CSI part 2 using a combinatorial indicator selected from a set of

$$( \begin{matrix}{N}_{1} {N}_{2} \\ {L}_{n}\end{matrix} )$$

codepoints. For all the selected N CSI-RS resources, the SD basis oversampling group for each CSI-RS resource can be indicated in CSI part 2 using an indicator selected from a set of O₁O₂ codepoints, where O₁ and O₂ are oversampling quantities.

A UE can communicate with a number of TRPs using beams. A TRP is a network node configured to transmit and receive signals. For example, a TRP can include one or more components of a base station. In some cases, a UE can communicate with multiple TRPs simultaneously (e.g., at the same time) in accordance with a mTRP configuration. In mTRP downlink communications, the UE can receive a number of communications, each from a different TRP.

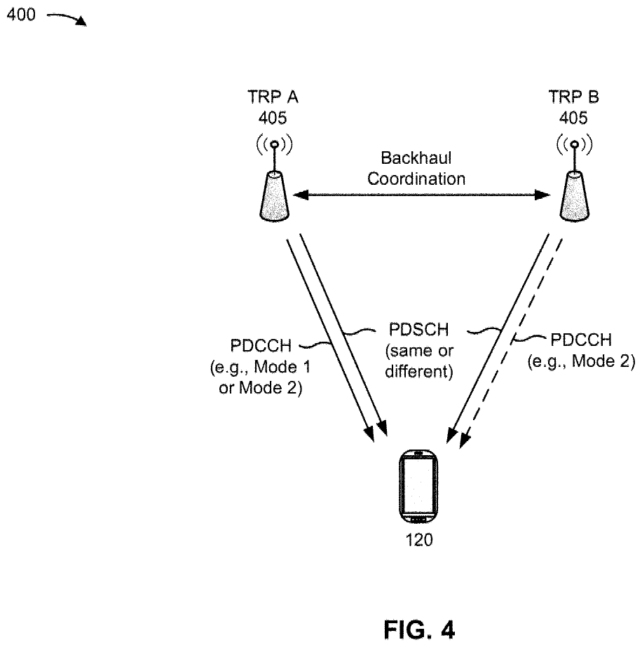

FIG. 4 is a diagram illustrating an example 400 of mTRP communication (sometimes referred to as multi-panel communication), in accordance with the present disclosure. As shown in FIG. 4, multiple TRPs 405 can communicate with the same UE 120. A network node can include multiple TRPs 405, or multiple TRPs 405 can be distributed across multiple network nodes.

The multiple TRPs 405 (shown as TRP A and TRP B) can communicate with the same UE 120 in a coordinated manner (e.g., using coordinated multipoint transmissions) to improve reliability and/or increase throughput. The TRPs 405 can coordinate such communications via an interface between the TRPs 405 (e.g., a backhaul interface and/or an access node controller). The interface can have a smaller delay and/or higher capacity when the TRPs 405 are co-located at the same network node (e.g., when the TRPs 405 are different antenna arrays or panels of the same network node), and can have a larger delay and/or lower capacity (as compared to co-location) when the TRPs 405 are located at different network nodes. The different TRPs 405 can communicate with the UE 120 using different quasi co-location (QCL) relationships (e.g., different transmission configuration indicator (TCI) states), different DMRS ports, and/or different layers (e.g., of a multi-layer communication).

In a first multi-TRP transmission mode (e.g., Mode 1), a single physical downlink control channel (PDCCH) can be used to schedule downlink data communications for a single physical downlink shared channel (PDSCH). In this case, multiple TRPs 405 (e.g., TRP A and TRP B) can transmit communications to the UE 120 on the same PDSCH. For example, a communication can be transmitted using a single codeword with different spatial layers for different TRPs 405 (e.g., where one codeword maps to a first set of layers transmitted by a first TRP 405 and maps to a second set of layers transmitted by a second TRP 405). As another example, a communication can be transmitted using multiple codewords, where different codewords are transmitted by different TRPs 405 (e.g., using different sets of layers). In either case, different TRPs 405 can use different QCL relationships (e.g., different TCI states) for different DMRS ports corresponding to different layers. For example, a first TRP 405 can use a first QCL relationship or a first TCI state for a first set of DMRS ports corresponding to a first set of layers, and a second TRP 405 can use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) can indicate the first QCL relationship (e.g., by indicating a first TCI state) and the second QCL relationship (e.g., by indicating a second TCI state). The first and the second TCI states can be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs can be used to schedule downlink data communications for multiple corresponding PDSCHs (e.g., one PDCCH for each PDSCH). In this case, a first PDCCH can schedule a first codeword to be transmitted by a first TRP 405, and a second PDCCH can schedule a second codeword to be transmitted by a second TRP 405. Furthermore, first DCI (e.g., transmitted by the first TRP 405) can schedule a first PDSCH communication associated with a first set of DMRS ports with a first QCL relationship (e.g., indicated by a first TCI state) for the first TRP 405, and second DCI (e.g., transmitted by the second TRP 405) can schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) can indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

Each communication in an mTRP configuration can be a spatial layer of a joint communication associated with a physical downlink shared channel (PDSCH). A joint communication is a communication that includes more than one signal that shares one or more time resources. Each TRP can be disposed at a different location than each other TRP and, as a result, each respective communication can be associated with one or more different respective spatial resources. Thus, each respective communication can be a spatial layer of the joint communication. A spatial layer of a joint communication is a portion of the joint communication that corresponds to a set of spatial resources. For example, a joint communication can include a first spatial layer corresponding to a first set of spatial resources and a second spatial layer corresponding to a second set of spatial resources.

To receive a joint communication from the multiple TRPs, a single wide beam corresponding to a single TCI state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a CJT configuration can be used for a coherent joint communication to facilitate more efficient application of spatial filters, which can result in fewer missed signals and more spectral efficiency.

A CJT configuration can be used for PDSCH communications, PUCCH communications, and/or PUSCH communications. A CJT is a joint transmission in which each layer of the joint transmission is transmitted with a respective phase such that the layers can be constructively combined at a receiving device.

In some cases, an mTRP CJT codebook can be used for port selection in mTRP CJT scenarios. In some cases, the mTRP CJT codebook can be from the Rel-16 eType-II CSI codebook or the Rel-17 FeType-II CSI port selection codebook. One of the differences of FeType-II codebook compared with the eType-II codebook is the FD basis selection. In the eType-II codebook, when N₃≤19, the FD bases is arbitrarily selected in the whole FD domain and when N₃>19, the FD basis is selected in a rather large window in the two sides of FD basis 0. In the FeType-II codebook, regardless of the number of PMI Subbands (N₃), when M=2, the FD basis selection window is basis {0,1} (when N=2) or {0, 1, 2, 3} (when N=4). Thus, FD basis 0 is always selected and the other candidate bases are close to basis 0 (e.g., each FD basis window starts from FD basis 0).

However, in the mTRP CJT scenario, due to possible different propagation channel properties among TRPs, each TRP may be associated with a respective rank (e.g., TRP A may be associated with rank-2 and TRP B may be associated with rank-1). For the Type-II codebook refinement for CJT mTRP, the bitmaps for indicating the locations of NZCs can reuse a legacy design. Thus, the size of the bitmap for a selected TRP n (Bₙ) is, Bₙ=2LₙM. TRP-specific rank can result in near all-zero \tilde{W}₂ coefficients for some TRPs at some layers. Thus, reporting all-zero coefficients with a size-2LₙM bitmap may constitute an inefficient use of communication resources and/or computation resources.

Various aspects relate generally to using two-stage NZC bitmaps for Type-II CSI associated with mTRP CJT. Some aspects more specifically relate to receiving, at a UE, configuration information associated with reporting CSI associated with a plurality of TRPs for mTRP CJT and reporting the CSI based on receiving a plurality of CSI-RSs. In some aspects, the UE may report the CSI using a reporting communication that may be an mTRP CJT CSI report including a Type-II port selection codebook. In some aspects, the reporting communication may include two-stage NZC bitmaps. A first stage NZC bitmap may include all-zero indications that indicate whether, for a respective TRP and a respective communication layer (e.g., rank), the CSI coefficient matrix \tilde{W}₂ includes all zeros or at least one NZC. For each combination of TRP and communication layer associated with a CSI coefficient matrix having at least one NZC, a second stage NZC bitmap may indicate the CSI coefficients.

Particular aspects of the subject matter described in this disclosure can be implemented to realize one or more of the following potential advantages. In some examples, the described techniques can be used to extend Type-II codebook refinement for mTRP CJT scenarios, thereby providing for CSI acquisition for mTRP CJT. In some examples, the described techniques can be used to facilitate more efficient use of CSI resources and/or computational resources for reporting CSI for mTRP CJT.

As indicated above, FIG. 4 is provided as an example. Other examples may differ from what is described with regard to FIG. 4.

FIG. 5 is a diagram illustrating an example 500 associated with two-stage NZC bitmaps for TRP-specific CJT CSI reporting in accordance with the present disclosure. As shown in FIG. 5, a UE 502 and a network node 504 may communicate with one another. In some aspects, the UE 502 may be, be similar to, include, or be included in, the UE 120 depicted in FIGS. 1-4. In some aspects, the network node 504 may be, be similar to, include, or be included in, the network node 110 depicted in FIGS. 1, 2, and 4, and/or one or more components of the disaggregated base station architecture 300 depicted in FIG. 3. The network node 504 may be or include a plurality of TRPs.

As shown by reference number 506, the network node 504 may transmit, and the UE 502 may receive, configuration information. The configuration information may be associated with reporting CSI associated with a plurality of TRPs for mTRP CJT. In some aspects, the configuration information may configure the UE 502 to report two-stage NZC bitmaps for TRP-specific CJT CSI reporting.

For example, the configuration information may configure a first stage NZC bitmap that includes a plurality of all-zero indications. Each all-zero indication may correspond to a respective TRP of the plurality of TRPs and to a respective communication layer of a plurality of communication layers. For example, a first all-zero indication may correspond to a first TRP and a first communication layer (e.g., a first rank), a second all-zero indication may correspond to the first TRP and a second communication layer, a third all-zero indication may correspond to a second TRP and the first communication layer, a fourth all-zero indication may correspond to the second TRP and the second communication layer, and so on. Each all-zero indication may indicate that, for the corresponding TRP and communication layer, a set of CSI coefficients includes either all zeros or at least one NZC. For example, an all-zero indication having a value of 0 may indicate that the corresponding set of CSI coefficients includes only zeros, while an all-zero indication having a value of 1 may indicate that the corresponding set of CSI coefficients includes at least one NZC. For each all-zero indication indicating at least one NZC, a second stage bitmap may indicate the corresponding CSI coefficients.

In some aspects, the configuration information may indicate a maximum total quantity of non-zero bits associated with a first stage bitmap. In some aspects, the maximum total quantity of non-zero bits may include a maximum total quantity of TRPs associated with all communication layers of the plurality of communication layers. For example, the maximum total quantity of non-zero bits associated with a first stage bitmap may be specified as a maximum number of TRPs across all layers (N_{max,allLayers}), of all TRPs of the plurality of TRPs having an associated set of CSI coefficients having at least one NZC. In some aspects, the maximum total quantity of non-zero bits associated with the first stage bitmap may be configured via a portion parameter β_{block}, and N_{max,allLayers} may be determined by β_{block}, the number of TRPs (N_{TRP} or N), and/or rank. For example, N_{max,allLayers}=β_{block}·N·rank, or β_{block} N_{TRP}·rank, or β_{block}·N_{TRP}·2 (calculated assuming rank-2). In some aspects, the maximum total quantity of non-zero bits may include a maximum total quantity of SD bases associated with all communication layers of the plurality of communication layers. For example, the maximum total quantity of non-zero bits may be specified as a maximum total number of SD basis selected across all layers (L_{max,allLayers}) and may be configured via the portion parameter β_{block}. L_{max,allLayers} may be determined by β_{block}, a total number of selected SD bases for a single-layer

$$\begin{matrix}( {L}_{total , singleLayer} = \\ {\sum }_{n = 1}^{{N}_{TRP}} {L}_{n} ) ,\end{matrix}$$

and/or rank. For example, L_{max,allLayers}=β_{block}·L_{total,singleLayer}·rank, or β_{block}·L_{total,singleLayer}·2 (calculated assuming rank-2). In some aspects, the portion parameter β_{block} may be configured as a parameter in a ParamCombo for Type-II-CJT.

In some aspects, the configuration information may configure TRP selection and an SD selection report. For example, in some aspects, the first stage NZC bitmap may be based on a plurality of SD basis combinations. In some aspects, the configuration information may indicate a plurality of quantity combinations, Lₙ-combinations, of selected SD bases, Lₙ-combinations. In some aspects, a wireless communication standard may specify the plurality of quantity combinations of selected SD bases. Each quantity combination of selected SD bases may correspond to a combination of TRPs of a plurality of combinations of TRPs. For example, in some aspects, and as illustrated in Table 1, the Lₙ-combinations may be per-TRP configured. In some aspects, and as illustrated in Table 2, the Lₙ-combinations may be per-Nvalue defined by a wireless communication standard, or per-Nvalue configured.

TABLE 1

| | Lₙ-selection | |
|---|---|---|
| TRP-combination | index | Lₙ-combination |
| {A, B, C, D} | 00 | {2, 2, 2, 2} |
| | 01 | {3, 2, 2, 1} |
| | 10 | {4, 2, 1, 1} |
| | 11 | {3, 3, 1, 1} |
| {A, B, C} | 00 | {3, 3, 2} |
| | 01 | {3, 2, 3} |
| | 10 | {4, 2, 2} |
| | 11 | {4, 4, 1} |
| {A, C, D} | 00 | {3, 3, 2} |
| | 01 | {3, 2, 3} |
| | 10 | {2, 3, 3} |
| | 11 | {4, 2, 2} |
| . . . | . . . | . . . |

TABLE 2

| N (number of TRPs | Lₙ-selection | |
|---|---|---|
| selected) | index | Lₙ-combination |
| 4 | 00 | {2, 2, 2, 2} |
| | 01 | {3, 2, 2, 1} |
| | 10 | {4, 2, 1, 1} |
| | 11 | {3, 3, 1, 1} |
| 3 | 00 | {3, 3, 2} |
| | 01 | {3, 2, 3} |
| | 10 | {4, 2, 2} |
| | 11 | {4, 4, 1} |
| 2 | 00 | {4, 4} |
| | 01 | {5, 3} |
| | 10 | {6, 2} |
| | 11 | {3, 5} |

In some other aspects, the Lₙ-combinations may be configured independent of TRP selection. For example, for 4-TRP {A, B, C, D} configured with Lₙ-combination {2, 2, 2, 2}, any TRP selection may automatically result in a subset of {2, 2, 2, 2}.

As shown by reference number 508, the network node 504 may transmit, and the UE 502 may receive, a plurality of CSI-RSs. The plurality of CSI-RSs may be associated with (e.g., transmitted by) a plurality of TRPs. As shown by reference number 510, the UE 502 may transmit, and the network node 504 may receive, a reporting communication. The reporting communication may be based on the configuration information and the plurality of precoded CSI-RSs. In some aspects, the reporting communication may include an mTRP CJT CSI report including a Type-II port selection codebook.

In some aspects, the reporting communication may include two-stage NZC bitmaps. For example, in some aspects, the reporting communication may include a first NZC bitmap and a second NZC bitmap. The first NZC bitmap may be a first stage NZC bitmap and may include a plurality of all-zero indications. Each all-zero indication may correspond to a respective TRP of the plurality of TRPs and a respective communication layer of a plurality of communication layers. A first all-zero indication, of the plurality of all-zero indications, may indicate that a first set of CSI coefficients, associated with a first TRP of the plurality of TRPs and a first communication layer of the plurality of communication layers, includes at least one NZC. The second NZC bitmap may be a second stage NZC bitmap that indicates the first set of CSI coefficients. In some aspects, a second all-zero indication, of the plurality of all-zero indications, may indicate that a second set of CSI coefficients, associated with a second TRP of the plurality of TRPs and a second communication layer of the plurality of communication layers, consists of only zeros. Based on that indication, the reporting communication may omit a bitmap indicating the second set of CSI coefficients (e.g., since that bitmap would indicate only zeros).

In some aspects, as shown in FIG. 5, the reporting communication may include an uplink control information (UCI) part 1 512 and a UCI part 2 514. The UCI part 1 also may be referred to as a CSI part 1 and the UCI part 2 may be referred to as a CSI part 2. In some aspects, the UCI part 1 512 may include a fixed payload size (smaller than the UCI part 2 514, and transmitted with higher reliability), and the network node 504 may be able to determine the (larger) payload size of UCI part 2 514 based on the decoded UCI part 1 512. For example, both the rank indicator (RI) (indicating the number of layers) and NNZC (number of non-zero coefficients (NZCs)) may be used to determine the payload size of the UCI part 2 514.

As shown, for example, the UCI part 1 512 may include the RI, a channel quality indicator (CQI), and the NNZC. The UCI part 1 512 also may include a TRP selection indication (e.g., an N_{TRP}-bit bitmap), an Lₙ-combination selection indication, and an indication of the total SD bases selected across all layers (L_{allLayers}). The UCI part 2 514 may include an SD beam selection indication (that indicates the L selected beams), an FD basis selection for each communication layer, a strongest coefficient indication (SCI) for each layer, a first stage NZC bitmap (e.g., the first bitmap discussed above), a second stage NZC bitmap for each layer for which at least one NZC is indicated by the first stage NZC bitmap, and an indication of quantization of the NZCs for each layer (e.g., which may indicate amplitude and/or phase quantization). Upon receiving the reporting communication, the network node 504 may decode the UCI part 1 512 and, based on the decoded UCI part 1 512, may decode the UCI part 2 514.

In some aspects, a size of the second stage bitmap may be based on a quantity of SD bases associated with the first TRP and a quantity of FD bases associated with the CSI. For example, the network node 504 may determine, from the decoded UCI part 1 512, the payload size of the second bitmap base on a total number of SD basis selected across all layers (L_{allLayers}). In some aspects,

$${L}_{allLayers} = {\sum }_{n = 1}^{N} {\sum }_{l = 0}^{rank - 1} {Z}_{n , l} {L}_{n} ,$$

where Z_{n,l} represents the first stage bitmap. The payload size, 2L_{allLayers}M, of the second stage bitmap may be determined by 2L_{allLayers}

$$M = {\sum }_{n = 1}^{N} {\sum }_{l = 0}^{rank - 1} {Z}_{n , l} \cdot 2 {L}_{n} M .$$

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 502) performs operations associated with two-stage NZC bitmaps for TRP-specific CJT.

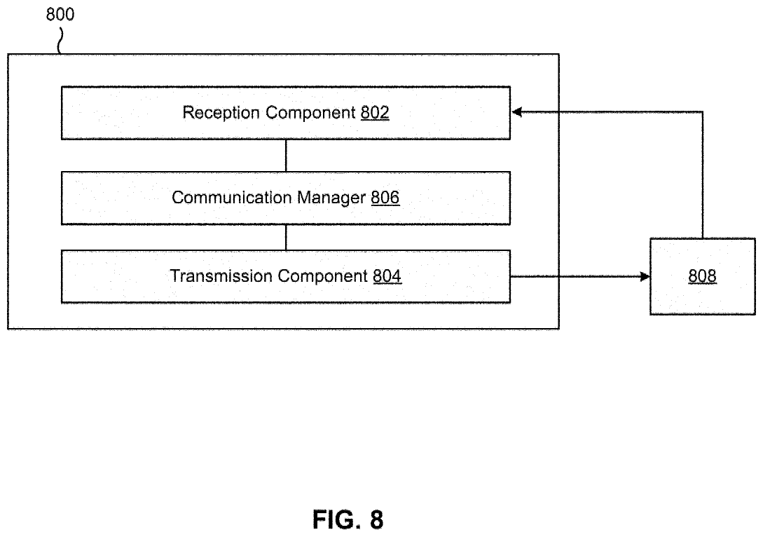

As shown in FIG. 6, in some aspects, process 600 may include receiving configuration information associated with reporting CSI associated with a plurality of TRPs for multiple TRP (mTRP) CJT (block 610). For example, the UE (e.g., using reception component 802 and/or communication manager 806, depicted in FIG. 8) may receive configuration information associated with reporting CSI associated with a plurality of TRPs for multiple TRP (mTRP) CJT, as described above.

As further shown in FIG. 6, in some aspects, process 600 may include receiving a plurality of CSI-RSs from the plurality of TRPs (block 620). For example, the UE (e.g., using reception component 802 and/or communication manager 806, depicted in FIG. 8) may receive a plurality of CSI-RSs from the plurality of TRPs, as described above.

As further shown in FIG. 6, in some aspects, process 600 may include transmitting a reporting communication based on the configuration information and the plurality of CSI-RSs, the reporting communication comprising two-stage NZC bitmaps including: a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC, and a second NZC bitmap indicating the first set of CSI coefficients (block 630). For example, the UE (e.g., using transmission component 804 and/or communication manager 806, depicted in FIG. 8) may transmit a reporting communication based on the configuration information and the plurality of CSI-RSs, the reporting communication comprising two-stage NZC bitmaps including: a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC, and a second NZC bitmap indicating the first set of CSI coefficients, as described above.

Process 600 may include additional aspects, such as any single aspect or any combination of aspects described below and/or in connection with one or more other processes described elsewhere herein.

In a first aspect, a second all-zero indication, of the plurality of all-zero indications, indicates that a second set of CSI coefficients, associated with a second TRP of the plurality of TRPs and a second communication layer of the plurality of communication layers, consists of zeros. In a second aspect, alone or in combination with the first aspect, the reporting communication omits a bitmap indicating the second set of CSI coefficients.

In a third aspect, alone or in combination with one or more of the first and second aspects, a size of the second bitmap is based on a quantity of combinations of selected SD bases associated with the first TRP and a quantity of FD bases associated with the CSI. In a fourth aspect, alone or in combination with one or more of the first through third aspects, the reporting communication comprises a CSI part 2 communication. In a fifth aspect, alone or in combination with the fourth aspect, process 600 includes transmitting a CSI part 1 communication indicating a total quantity of selected SD bases associated with the plurality of TRPs and the plurality of communication layers. In a sixth aspect, alone or in combination with the fifth aspect, a payload size associated with the CSI part 2 communication is based on the total quantity of selected SD bases.

In a seventh aspect, alone or in combination with one or more of the first through sixth aspects, the configuration information indicates a maximum total quantity of non-zero bits associated with the first bitmap. In an eighth aspect, alone or in combination with the seventh aspect, the maximum total quantity of non-zero bits comprises a maximum total quantity of TRPs associated with all communication layers of the plurality of communication layers. In a ninth aspect, alone or in combination with the seventh aspect, the maximum total quantity of non-zero bits comprises a maximum total quantity of SD bases associated with all communication layers of the plurality of communication layers. In a tenth aspect, alone or in combination with the seventh aspect, the maximum total quantity of non-zero bits is based on a portion parameter value. In an eleventh aspect, alone or in combination with the tenth aspect, the configuration information indicates the portion parameter value.

In a twelfth aspect, alone or in combination with one or more of the first through eleventh aspects, the configuration information indicates a plurality of quantity combinations of selected SD bases, wherein each quantity combination of selected SD bases, of the plurality of quantity combinations of SD bases, corresponds to a combination of TRPs of a plurality of combinations of TRPs. In a thirteenth aspect, alone or in combination with one or more of the first through twelfth aspects, the first NZC bitmap is based on a plurality of quantity combinations of selected SD bases, wherein each quantity combination of selected SD bases, of the plurality of quantity combinations of selected SD bases, corresponds to a quantity of selected TRPs of the plurality of TRPs. In a fourteenth aspect, alone or in combination with the thirteenth aspect, the configuration information indicates a plurality of quantity combinations of selected SD bases. In a fifteenth aspect, alone or in combination with one or more of the first through fourteenth aspects, the configuration information indicates a plurality of quantity combinations of selected SD bases, wherein each quantity combination of selected SD bases, of the plurality of quantity combinations of selected SD bases, is independent of a TRP selection.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with two-stage NZC bitmaps for TRP-specific CJT.

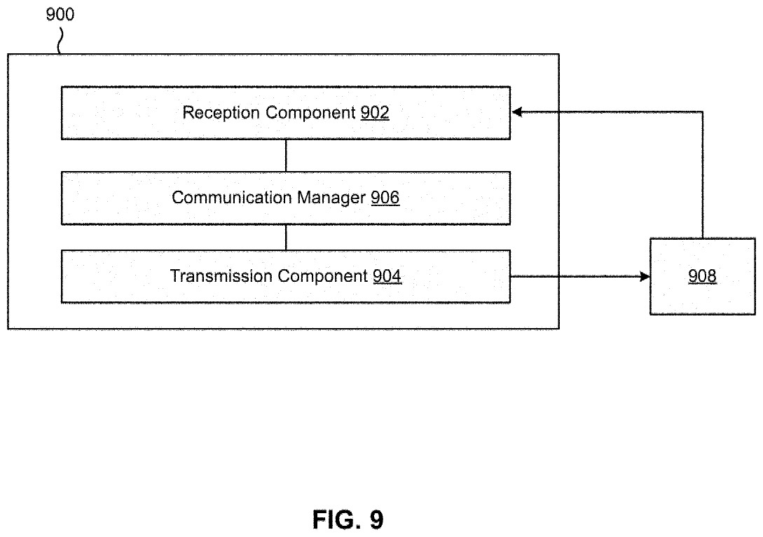

As shown in FIG. 7, in some aspects, process 700 may include transmitting configuration information associated with reporting CSI associated with a plurality of TRPs for multiple TRP (mTRP) CJT, the configuration information indicating a two-stage NZC bitmap configuration (block 710). For example, the network node (e.g., using transmission component 904 and/or communication manager 906, depicted in FIG. 9) may transmit configuration information associated with reporting CSI associated with a plurality of TRPs for multiple TRP (mTRP) CJT, the configuration information indicating a two-stage NZC bitmap configuration, as described above.

As further shown in FIG. 7, in some aspects, process 700 may include transmitting a plurality of CSI-RSs from the plurality of TRPs (block 720). For example, the network node (e.g., using transmission component 904 and/or communication manager 906, depicted in FIG. 9) may transmit a plurality of CSI-RSs from the plurality of TRPs, as described above.

As further shown in FIG. 7, in some aspects, process 700 may include receiving a reporting communication based on the configuration information and the plurality of CSI-RSs, the reporting communication comprising: a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second bitmap indicating the first set of CSI coefficients (block 730). For example, the network node (e.g., using reception component 902 and/or communication manager 906, depicted in FIG. 9) may receive a reporting communication based on the configuration information and the plurality of CSI-RSs, the reporting communication comprising: a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second bitmap indicating the first set of CSI coefficients, as described above.

Process 700 may include additional aspects, such as any single aspect or any combination of aspects described below and/or in connection with one or more other processes described elsewhere herein.

In a first aspect, a second all-zero indication, of the plurality of all-zero indications, indicates that a second set of CSI coefficients, associated with a second TRP of the plurality of TRPs and a second communication layer of the plurality of communication layers, consists of zeros. In a second aspect, alone or in combination with the first aspect, the reporting communication omits a bitmap indicating the second set of CSI coefficients. In a third aspect, alone or in combination with one or more of the first and second aspects, a size of the second bitmap is based on a quantity of SD bases associated with the first TRP and a quantity of FD bases associated with the CSI. In a fourth aspect, alone or in combination with one or more of the first through third aspects, the reporting communication comprises a CSI part 2 communication. In a fifth aspect, alone or in combination with the fourth aspect, process 700 includes receiving a CSI part 1 communication indicating a total quantity of selected SD bases associated with the plurality of TRPs and the plurality of communication layers. In a sixth aspect, alone or in combination with the fifth aspect, a payload size associated with the CSI part 2 communication is based on the total quantity of selected SD bases.

In a seventh aspect, alone or in combination with one or more of the first through sixth aspects, the configuration information indicates a maximum total quantity of non-zero bits associated with the first bitmap. In an eighth aspect, alone or in combination with the seventh aspect, the maximum total quantity of non-zero bits comprises a maximum total quantity of TRPs associated with all communication layers of the plurality of communication layers. In a ninth aspect, alone or in combination with the seventh aspect, the maximum total quantity of non-zero bits comprises a maximum total quantity of SD bases associated with all communication layers of the plurality of communication layers. In a tenth aspect, alone or in combination with the seventh aspect, the maximum total quantity of non-zero bits is based on a portion parameter value. In an eleventh aspect, alone or in combination with the tenth aspect, the configuration information indicates the portion parameter value.

In a twelfth aspect, alone or in combination with one or more of the first through eleventh aspects, the configuration information indicates a plurality of quantity combinations of selected SD bases, wherein each quantity combination of selected SD bases, of the plurality of quantity combinations of SD bases, corresponds to a combination of TRPs of a plurality of combinations of TRPs. In a thirteenth aspect, alone or in combination with one or more of the first through twelfth aspects, the first NZC bitmap is based on a plurality of quantity combinations of selected SD bases, wherein each quantity combination of selected SD bases, of the plurality of quantity combinations of selected SD bases, corresponds to a quantity of selected TRPs of the plurality of TRPs. In a fourteenth aspect, alone or in combination with the thirteenth aspect, the configuration information indicates a plurality of quantity combinations of selected SD bases. In a fifteenth aspect, alone or in combination with one or more of the first through fourteenth aspects, the configuration information indicates a plurality of quantity combinations of selected SD bases, wherein each quantity combination of selected SD bases, of the plurality of quantity combinations of selected SD bases, is independent of a TRP selection.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive configuration information associated with reporting CSI associated with a plurality of TRPs for multiple TRP (mTRP) CJT. The reception component 802 may receive a plurality of CSI-RSs from the plurality of TRPs. The transmission component 804 may transmit a reporting communication based on the configuration information and the plurality of CSI-RSs, the reporting communication comprising two-stage NZC bitmaps including a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC, and a second NZC bitmap indicating the first set of CSI coefficients. The transmission component 804 may transmit a CSI part 1 communication indicating a total quantity of selected SD bases associated with the plurality of TRPs and the plurality of communication layers.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit configuration information associated with reporting CSI associated with a plurality of TRPs for multiple TRP (mTRP) CJT, the configuration information indicating a two-stage NZC bitmap configuration. The transmission component 904 may transmit a plurality of CSI-RSs from the plurality of TRPs. The reception component 902 may receive a reporting communication based on the configuration information and the plurality of CSI-RSs, the reporting communication comprising a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second bitmap indicating the first set of CSI coefficients. The reception component 902 may receive a CSI part 1 communication indicating a total quantity of selected SD bases associated with the plurality of TRPs and the plurality of communication layers.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving configuration information associated with reporting channel state information (CSI) associated with a plurality of transmission reception points (TRPs) for multiple TRP (mTRP) coherent joint transmission (CJT); receiving a plurality of channel state information (CSI) reference signals (CSI-RSs) from the plurality of TRPs; and transmitting a reporting communication based on the configuration information and the plurality of CSI-RSs, the reporting communication comprising two-stage non-zero coefficient (NZC) bitmaps including: a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second NZC bitmap indicating the first set of CSI coefficients.

Aspect 2: The method of Aspect 1, wherein a second all-zero indication, of the plurality of all-zero indications, indicates that a second set of CSI coefficients, associated with a second TRP of the plurality of TRPs and a second communication layer of the plurality of communication layers, consists of zeros.

Aspect 3: The method of Aspect 2, wherein the reporting communication omits a bitmap indicating the second set of CSI coefficients.

Aspect 4: The method of any of Aspects 1-3, wherein a size of the second bitmap is based on a quantity of spatial domain bases associated with the first TRP and a quantity of frequency domain bases associated with the CSI.

Aspect 5: The method of any of Aspects 1-4, wherein the reporting communication comprises a CSI part 2 communication.

Aspect 6: The method of Aspect 5, further comprising transmitting a CSI part 1 communication indicating a total quantity of selected spatial domain bases associated with the plurality of TRPs and the plurality of communication layers.

Aspect 7: The method of Aspect 6, wherein a payload size associated with the CSI part 2 communication is based on the total quantity of selected spatial domain bases.

Aspect 8: The method of any of Aspects 1-7 wherein the configuration information indicates a maximum total quantity of non-zero bits associated with the first bitmap.

Aspect 9: The method of Aspect 8, wherein the maximum total quantity of non-zero bits comprises a maximum total quantity of TRPs associated with all communication layers of the plurality of communication layers.

Aspect 10: The method of any of Aspects 8-9, wherein the maximum total quantity of non-zero bits comprises a maximum total quantity of spatial domain bases associated with all communication layers of the plurality of communication layers.

Aspect 11: The method of any of Aspects 8-10, wherein the maximum total quantity of non-zero bits is based on a portion parameter value.

Aspect 12: The method of Aspect 11, wherein the configuration information indicates the portion parameter value.

Aspect 13: The method of any of Aspects 1-12, wherein the configuration information indicates a plurality of quantity combinations of selected spatial domain bases, wherein each quantity combination of selected spatial domain bases, of the plurality of quantity combinations of selected spatial domain bases, corresponds to a combination of TRPs of a plurality of combinations of TRPs.

Aspect 14: The method of any of Aspects 1-12, wherein the first NZC bitmap is based on a plurality of quantity combinations of selected spatial domain bases, wherein each quantity combination of selected spatial domain bases, of the plurality of quantity combinations of selected spatial domain bases, corresponds to a quantity of selected TRPs of the plurality of TRPs.

Aspect 15: The method of Aspect 14, wherein the configuration information indicates the plurality of quantity combinations of selected spatial domain bases.

Aspect 16: The method of any of Aspects 1-12, wherein the configuration information indicates a plurality of quantity combinations of selected spatial domain bases, wherein each quantity combination of selected spatial domain bases, of the plurality of quantity combinations of selected spatial domain bases, is independent of a TRP selection.

Aspect 17: A method of wireless communication performed by a network node, comprising: transmitting configuration information associated with reporting channel state information (CSI) associated with a plurality of transmission reception points (TRPs) for multiple TRP (mTRP) coherent joint transmission (CJT), the configuration information indicating a two-stage non-zero coefficient (NZC) bitmap configuration; transmitting a plurality of channel state information (CSI) reference signals (CSI-RSs) from the plurality of TRPs; and receiving a reporting communication based on the configuration information and the plurality of CSI-RSs, the reporting communication comprising: a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and a second bitmap indicating the first set of CSI coefficients.

Aspect 18: The method of Aspect 17, wherein a second all-zero indication, of the plurality of all-zero indications, indicates that a second set of CSI coefficients, associated with a second TRP of the plurality of TRPs and a second communication layer of the plurality of communication layers, consists of zeros.

Aspect 19: The method of Aspect 18, wherein the reporting communication omits a bitmap indicating the second set of CSI coefficients.

Aspect 20: The method of any of Aspects 17-19, wherein a size of the second bitmap is based on a quantity of spatial domain bases associated with the first TRP and a quantity of frequency domain bases associated with the CSI.

Aspect 21: The method of any of Aspects 17-20, wherein the reporting communication comprises a CSI part 2 communication.

Aspect 22: The method of Aspect 21, further comprising receiving a CSI part 1 communication indicating a total quantity of selected spatial domain bases associated with the plurality of TRPs and the plurality of communication layers.

Aspect 23: The method of Aspect 22, wherein a payload size associated with the CSI part 2 communication is based on the total quantity of selected spatial domain bases.

Aspect 24: The method of any of Aspects 17-23, wherein the configuration information indicates a maximum total quantity of non-zero bits associated with the first bitmap.

Aspect 25: The method of Aspect 24, wherein the maximum total quantity of non-zero bits comprises a maximum total quantity of TRPs associated with all communication layers of the plurality of communication layers.

Aspect 26: The method of any of Aspects 24-25, wherein the maximum total quantity of non-zero bits comprises a maximum total quantity of spatial domain bases associated with all communication layers of the plurality of communication layers.

Aspect 27: The method of any of Aspects 24-26, wherein the maximum total quantity of non-zero bits is based on a portion parameter value.

Aspect 28: The method of Aspect 27, wherein the configuration information indicates the portion parameter value.

Aspect 29: The method of any of Aspects 17-28, wherein the configuration information indicates a plurality of quantity combinations of selected spatial domain bases, wherein each quantity combination of selected spatial domain bases, of the plurality of quantity combinations of selected spatial domain bases, corresponds to a combination of TRPs of a plurality of combinations of TRPs.

Aspect 30: The method of any of Aspects 17-28, wherein the first NZC bitmap is based on a plurality of quantity combinations of selected spatial domain bases, wherein each quantity combination of selected spatial domain bases, of the plurality of quantity combinations of selected spatial domain bases, corresponds to a quantity of selected TRPs of the plurality of TRPs.

Aspect 31: The method of Aspect 30, wherein the configuration information indicates the plurality of quantity combinations of selected spatial domain bases.

Aspect 32: The method of any of Aspects 17-28, wherein the configuration information indicates a plurality of quantity combinations of selected spatial domain bases, wherein each quantity combination of selected spatial domain bases, of the plurality of quantity combinations of selected spatial domain bases, is independent of a TRP selection.

Aspect 33: An apparatus for wireless communication at a device, comprising a processor; memory coupled with the processor; and instructions stored in the memory and executable by the processor to cause the apparatus to perform the method of one or more of Aspects 1-16.

Aspect 34: A device for wireless communication, comprising a memory and one or more processors coupled to the memory, the one or more processors configured to perform the method of one or more of Aspects 1-16.

Aspect 35: An apparatus for wireless communication, comprising at least one means for performing the method of one or more of Aspects 1-16.

Aspect 36: A non-transitory computer-readable medium storing code for wireless communication, the code comprising instructions executable by a processor to perform the method of one or more of Aspects 1-16.

Aspect 37: A non-transitory computer-readable medium storing a set of instructions for wireless communication, the set of instructions comprising one or more instructions that, when executed by one or more processors of a device, cause the device to perform the method of one or more of Aspects 1-16.

Aspect 38: An apparatus for wireless communication at a device, comprising a processor; memory coupled with the processor; and instructions stored in the memory and executable by the processor to cause the apparatus to perform the method of one or more of Aspects 17-32.

Aspect 39: A device for wireless communication, comprising a memory and one or more processors coupled to the memory, the one or more processors configured to perform the method of one or more of Aspects 17-32.

Aspect 40: An apparatus for wireless communication, comprising at least one means for performing the method of one or more of Aspects 17-32.

Aspect 41: A non-transitory computer-readable medium storing code for wireless communication, the code comprising instructions executable by a processor to perform the method of one or more of Aspects 17-32.

Aspect 42: A non-transitory computer-readable medium storing a set of instructions for wireless communication, the set of instructions comprising one or more instructions that, when executed by one or more processors of a device, cause the device to perform the method of one or more of Aspects 17-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors coupled to the memory, and configured to cause the UE to:
receive configuration information associated with reporting channel state information (CSI) associated with a plurality of transmission reception points (TRPs) for multiple TRP (mTRP) coherent joint transmission (CJT);
receive a plurality of channel state information (CSI) reference signals (CSI-RSs) from the plurality of TRPs; and
transmit a reporting communication based on the configuration information and the plurality of CSI-RSs, the reporting communication comprising two-stage non-zero coefficient (NZC) bitmaps including:
a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and
a second NZC bitmap indicating the first set of CSI coefficients.

2. The UE of claim 1, wherein a second all-zero indication, of the plurality of all-zero indications, indicates that a second set of CSI coefficients, associated with a second TRP of the plurality of TRPs and a second communication layer of the plurality of communication layers, consists of zeros.

3. The UE of claim 2, wherein the reporting communication omits a bitmap indicating the second set of CSI coefficients.

4. The UE of claim 1, wherein a size of the second bitmap is based on a quantity of spatial domain bases associated with the first TRP and a quantity of frequency domain bases associated with the CSI.

5. (canceled)

6. The UE of claim 1, wherein the one or more processors are further configured to cause the UE to transmit a CSI part 1 communication indicating a total quantity of selected spatial domain bases associated with the plurality of TRPs and the plurality of communication layers.

7. (canceled)

8. The UE of claim 1, wherein the configuration information indicates a maximum total quantity of non-zero bits associated with the first bitmap.

9. The UE of claim 8, wherein the maximum total quantity of non-zero bits comprises a maximum total quantity of TRPs associated with all communication layers of the plurality of communication layers.

10. The UE of claim 8, wherein the maximum total quantity of non-zero bits comprises a maximum total quantity of spatial domain bases associated with all communication layers of the plurality of communication layers.

11. The UE of claim 1, wherein the configuration information indicates a plurality of quantity combinations of selected spatial domain bases, wherein each quantity combination of selected spatial domain bases, of the plurality of quantity combinations of selected spatial domain bases, corresponds to a combination of TRPs of a plurality of combinations of TRPs.

12. The UE of claim 1, wherein the first NZC bitmap is based on a plurality of quantity combinations of selected spatial domain bases, wherein each quantity combination of selected spatial domain bases, of the plurality of quantity combinations of selected spatial domain bases, corresponds to a quantity of selected TRPs of the plurality of TRPs.

13. The UE of claim 12, wherein the configuration information indicates the plurality of quantity combinations of selected spatial domain bases.

14. The UE of claim 1, wherein the configuration information indicates a plurality of quantity combinations of selected spatial domain bases, wherein each quantity combination of selected spatial domain bases, of the plurality of quantity combinations of selected spatial domain bases, is independent of a TRP selection.

15. A network node for wireless communication, comprising:
a memory; and
one or more processors coupled to the memory, and configured to cause the network node to:
transmit configuration information associated with reporting channel state information (CSI) associated with a plurality of transmission reception points (TRPs) for multiple TRP (mTRP) coherent joint transmission (CJT), the configuration information indicating a two-stage non-zero coefficient (NZC) bitmap configuration;
transmit a plurality of channel state information (CSI) reference signals (CSI-RSs) from the plurality of TRPs; and
receive a reporting communication based on the configuration information and the plurality of CSI-RSs, the reporting communication comprising:
a first bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients, associated with a first TRP of the plurality of TRPs and a first communication layer of the plurality of communication layers, comprises at least one NZC; and
a second bitmap indicating the first set of CSI coefficients.

16. The network node of claim 15, wherein a second all-zero indication, of the plurality of all-zero indications, indicates that a second set of CSI coefficients, associated with a second TRP of the plurality of TRPs and a second communication layer of the plurality of communication layers, consists of zeros.

17-21. (canceled)

22. The network node of claim 15, wherein a maximum total quantity of non-zero bits indicated by the configuration information comprises a maximum total quantity of TRPs associated with all communication layers of the plurality of communication layers.

23. The network node of claim 15, wherein a maximum total quantity of non-zero bits indicated by the configuration information comprises a maximum total quantity of spatial domain bases associated with all communication layers of the plurality of communication layers.

24. The network node of claim 15, wherein the configuration information indicates a plurality of quantity combinations of selected spatial domain bases, wherein each quantity combination of selected spatial domain bases, of the plurality of quantity combinations of selected spatial domain bases, corresponds to a combination of TRPs of a plurality of combinations of TRPs.

25. The network node of claim 15, wherein the first bitmap is based on a plurality of quantity combinations of selected spatial domain bases, wherein each quantity combination of selected spatial domain bases, of the plurality of quantity combinations of selected spatial domain bases, corresponds to a quantity of selected TRPs of the plurality of TRPs.

26. The network node of claim 15, wherein the configuration information indicates a plurality of quantity combinations of selected spatial domain bases, wherein each quantity combination of selected spatial domain bases, of the plurality of quantity combinations of selected spatial domain bases, is independent of a TRP selection.

27. A method of wireless communication performed by a user equipment (UE), comprising:
receiving configuration information associated with reporting channel state information (CSI) associated with a plurality of transmission reception points (TRPs) for multiple TRP (mTRP) coherent joint transmission (CJT);
receiving a plurality of channel state information (CSI) reference signals (CSI-RSs) from the plurality of TRPs; and
transmitting a reporting communication based on the configuration information and the plurality of CSI-RSs, the reporting communication comprising two-stage non-zero coefficient (NZC) bitmaps including:
a first NZC bitmap comprising a plurality of all-zero indications, each all-zero indication of the plurality of all-zero indications corresponding to a respective TRP of the plurality of TRPs and a respective communication layer of a plurality of communication layers, wherein a first all-zero indication, of the plurality of all-zero indications, indicates that a first set of CSI coefficients associated with a first TRP of the plurality of TRPs and a first communication layer of the plurality of communication layers, comprises at least one NZC; and
a second NZC bitmap indicating the first set of CSI coefficients.

28-30. (canceled)
